(19) United States
(12) Patent Application Publication
(10) Pub. No.: US 2012/0261871 A1
(43) Pub. Date: Oct. 18, 2012

(54) Cutting Board Device Integrally Supported By Countertop

(76) Inventor: Scott W. Kaufmann, Little River, SC (US)

(21) Appl. No.: 13/447,649

(22) Filed: Apr. 16, 2012

Related U.S. Application Data
(60) Provisional application No. 61/475,889, filed on Apr. 15, 2011.

(51) Int. Cl. A47J 47/00

(52) U.S. Cl. 269/16

(57) ABSTRACT

A cutting board device integrally supported by a countertop, the device having a platform detachably connected to a base. The cutting board device includes a means for removably attaching a plurality of implements to the cutting board device, and a lifting means for allowing the cutting board device to move between settable raised and lowered positions about an opening in the countertop.

### RELATED APPLICATIONS

This application claims the benefit of U.S. Provisional Application No. 61/475,889 filed on Apr. 15, 2011.

### BACKGROUND OF THE INVENTION

1. Field of the Invention

The present invention relates generally to cutting boards and, more particularly, to a cutting board device integrally supported by a countertop.

2. Description of the Related Art

The prior art discloses various devices and apparatuses for holding, storing, and/or organizing electrical appliances, tools, implements, and the like. However, none of the prior art devices disclose, show, or teach a cutting board having a means for removably attaching a plurality of implements to the platform thereof, a means for allowing the cutting board device to move between settable raised and lowered positions, nor a cutting board device integrally supported by a countertop.

Accordingly, a need exists for an improved cutting board device having an implement securing means and a cutting board lifting means. The development of the cutting board device as described herein fulfills this need.

A search of the prior art did not disclose any patents that read directly on the claims of the instant invention; however, the following references were considered related:

U.S. Patent Application no. 2009/0033012 A1, published in the name of Correa;

U.S. Pat. No. 1,223,161, issued in the name of Fazzini;

U.S. Pat. No. 4,017,063 issued in the name of Brusich;

U.S. Pat. No. 4,531,260, issued in the name of Klamm;

U.S. Pat. No. 5,386,755, issued in the name of Schneider et al.;

U.S. Pat. No. 6,318,222 B1, issued in the name of Weinman;

U.S. Pat. No. 7,059,952 B1, issued in the name of McRoberts;

U.S. Pat. No. 7,125,011 B2, issued in the name of McLaughlin; and

U.S. Pat. No. 7,758,029 B2, issued in the name of Lim et al.

Consequently, a need has been felt for an improved cutting board device having a means for removably attaching a plurality of implements thereto, a means for allowing the cutting board device to move between settable raised and lowered positions, and a cutting board device integrally supported by a countertop. This application presents claims and embodiments that fulfill a need or needs not yet satisfied by the products, inventions and methods previously or presently available. In particular, the claims and embodiments disclosed herein describe a cutting board device comprising: a platform; a base; the platform detachably connectable to the base; a means for detachably connecting the platform to the base; a means for removably attaching a plurality of implements to the cutting board device; and a lifting means for allowing the cutting board device to move between settable raised and lowered positions, the device of the present invention providing unanticipated and nonobvious combination of features distinguished from the products, inventions and methods preexisting in the art. The applicant is unaware of any product, method, disclosure or reference that discloses the features of the claims and embodiments disclosed herein.

### SUMMARY OF THE INVENTION

Briefly described according to one embodiment of the present invention, a cutting board device is disclosed, wherein the cutting board device comprises a platform detachably connected to a base. The platform has a planar upper surface and a planar lower surface. The platform includes a plurality of vertical side walls integrally joining the upper surface and lower surface.

The base includes a rear vertical wall having outer ends to which ends of a pair of vertical side walls are mounted perpendicularly or formed integral thereto.

An attachment means and complementary attachment means are provided, wherein attachment means and complementary attachment means facilitating removable attachment of platform to base.

A securement means is provided for removably attaching a plurality of implements, such as cutting instruments, to the cutting board device.

A lifting means is provided for allowing the cutting board device to move between settable raised and lowered positions. Lifting means comprises a pair of brackets each having a pair of lift members.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a top perspective view of a cutting board device shown integrally supported by a countertop, according to one embodiment of the present invention;

FIG. 2 is a top perspective view of a platform, according to one embodiment of the present invention;

FIG. 3 is a bottom plan view of the platform of FIG. 2 shown affixed with an attachment means;

FIG. 3A is bottom plan view of the platform of FIG. 2 illustrating a plurality of attachment means;

FIG. 4 is a top perspective view of a base, in accordance to one embodiment of the present invention;

FIG. 5 is a right side elevational view of the base, according to one embodiment of the present invention;

FIG. 5A is a left side elevational view of the base, according to one embodiment of the present invention;

FIG. 6 is a top perspective of the base of FIG. 4, shown affixed with a complementary attachment means, in accordance to one embodiment of the present invention;

FIG. 7 is a top plan view of a securement means, according to one embodiment of the present invention;

FIG. 8 is a front end elevational view of the securement means of FIG. 7;

FIG. 9 is a top perspective view of a base shown slidably engaged by a securement means, in accordance to one embodiment of the present invention;

FIG. 10 is a perspective view of a conventional knife;

FIG. 11 is a perspective view of a conventional countertop mounted atop a cabinet;

FIG. 12 is bottom perspective view of a cutting board device with a lifting means mounted to the base thereof, according to one embodiment of the present invention;

FIG. 13 is a right side elevational view of the cutting board device shown in a lowered, recessed position within an opening in a countertop; and

FIG. 14 is a left side elevational view of the cutting board device shown in a lowered, recessed position within an opening in a countertop.

### DESCRIPTION OF THE PREFERRED EMBODIMENT

### Detailed Description of the Figures

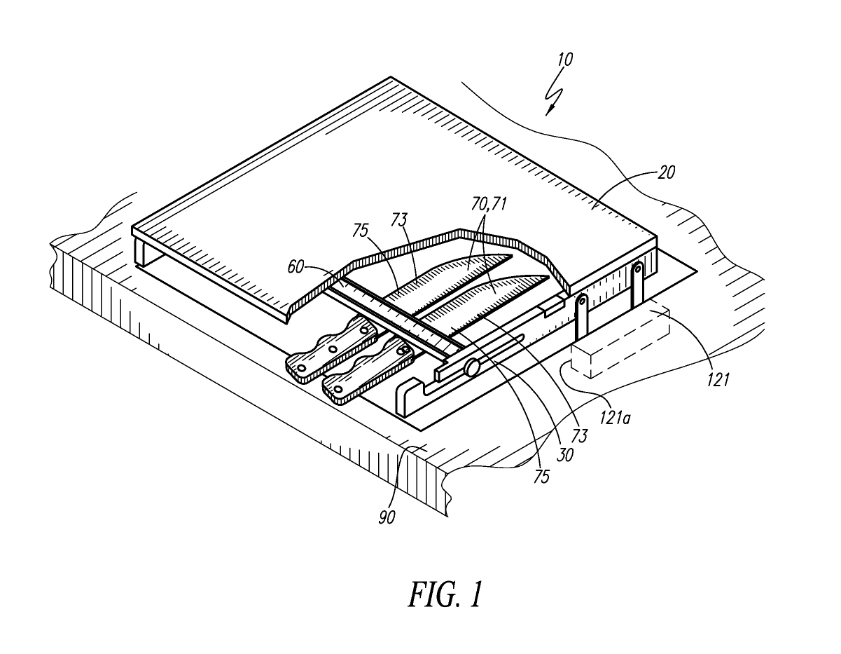

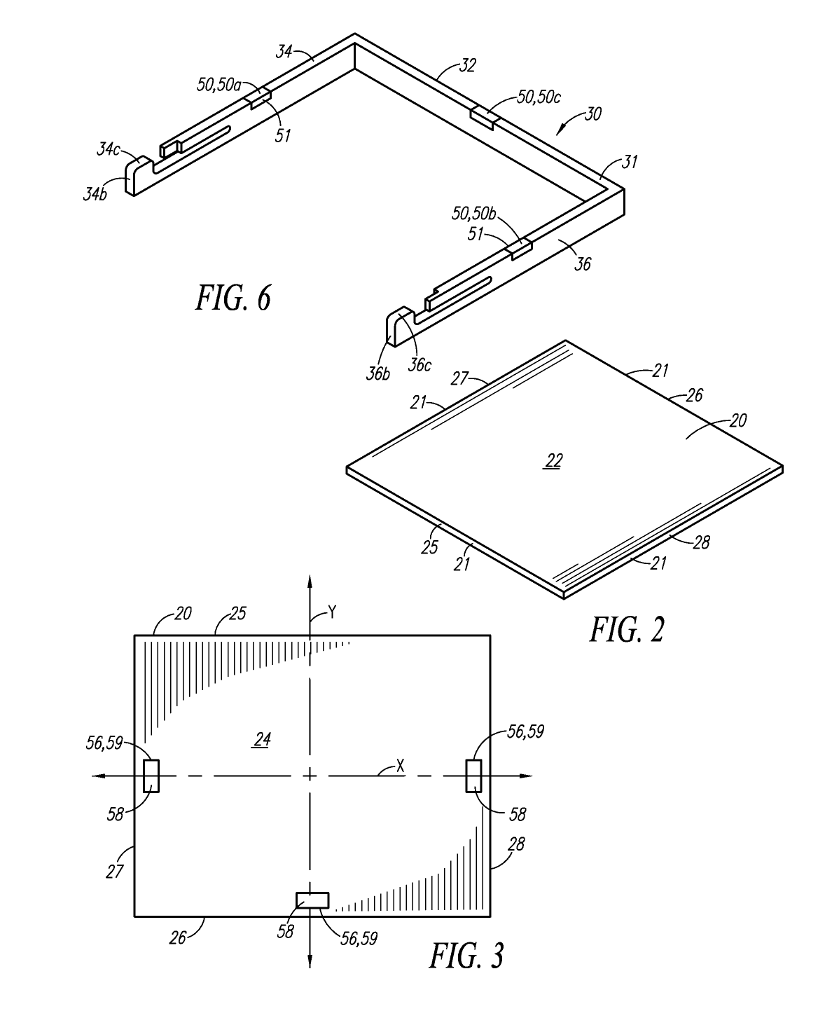

Referring now to FIGS. 1-6, a cutting board device 10 is shown, according to one embodiment of the present invention, wherein the cutting board device 10, hereinafter referred to as “device 10”, comprises a platform 20 detachably connected to a base 30. The platform 20 defines a perimeter measuring equal to or greater than a perimeter defining base 30, and preferably, platform 20 has a perimeter measuring greater than a perimeter defining base 30. The platform 20, preferably solid, comprises a planar, smooth upper surface 22 and a planar, smooth lower surface 24. The platform 20 includes a plurality of vertical side walls 21 integrally joining the upper surface 22 and lower surface 24. The plurality of vertical sidewalls 21 comprises a front side wall 25 opposing a rear side wall 26, and a first end side wall 27 opposing a second end side wall 28. The platform 20 further comprises an attachment means 56 suitably mounted to the lower surface 24 thereof.

The attachment means 56 is suitably affixed spatially about a perimeter of the lower surface 24 of platform 20 such that attachment means 56a is affixed adjacent to first end side wall 27 about horizontal axis X, attachment means 56b is affixed adjacent to second end side wall 28 about horizontal axis X, and attachment means 56c is affixed adjacent to rear side wall 26 about longitudinal axis Y. The attachment means 56 are oriented about the lower surface 24 of platform 20 so as to align with a complementary attachment means 50 (to be described later in greater detail) when placing the lower surface 24 of platform 20 atop an upper surface 31 of base 30.

The base 30 comprises a rear vertical wall 32 having outer ends to which ends of a pair of vertical side walls 34, 36 are respectively mounted perpendicularly or formed integral perpendicularly thereto, sidewall 34 joining end of rear vertical wall 32 at interface 38, and sidewall 36 joining opposing end of rear vertical wall 32 at interface 39. In order to enhance the structural integrity of base 30, a first support member 38a may be suitably mounted or formed integral between side wall 34 and vertical wall 32 at interface 38, and a second support member 39a may be suitably mounted or formed integral between side wall 36 and vertical wall 32 at interface 39.

Each side wall 34, 36 and rear vertical wall 32 includes a recess 34a, 36a, 32a, respectively, defined in an upper surface, about an elongated centerline each thereof, wherein each recess 34a, 36a, 32a supporting a complementary attachment means 50 suitably affixed therein for detachably engaging the attachment means 56 of platform 20. As illustrated in FIG. 6, recess 34a supports complementary attachment means 50a (plug 50a), recess 36a supports complementary attachment means 50b (plug 50b), and recess 32a supports complementary attachment means 50c (plug 50c). The complementary attachment means 50 is configured so as to have a shape and dimension substantially corresponding to a shape and dimension defining the space provided by each recess 34a, 36a, 32a, thereby allowing complementary attachment means 50 to reside within each respective recess 34a, 36a, 32a in a flush, shapely-conforming manner.

Each side wall 34, 36 further defines a forward vertical edge 34b, 36b, respectively, the forward vertical edge 34b, 36b of each respective side wall 34, 36 includes a generally flat upper edge 34c, 36c, respectively.

The platform 20 and base 30 are manufactured from a lightweight, rigid material, preferably wood. Alternatively, platform 20 and base 30 may be constructed of a lightweight, rigid material selected from the group comprising plastic, thermoplastic, metal or a metallic-plastic composite. Preferred plastic or thermoplastic materials include polyvinyl chloride (PVC), polypropylene, polyolefin, acrylonitrile-butadiene-styrene (ABS), polyethylene, polyurethane, polycarbonate, or blends thereof, and ABS/Nylon blend. In the event plastic is the selected fabrication material, platform 20 and base 30 may fabricated utilizing a common molding process such as injection molding, blow molding, extrusion, or other molding and fabricating methods.

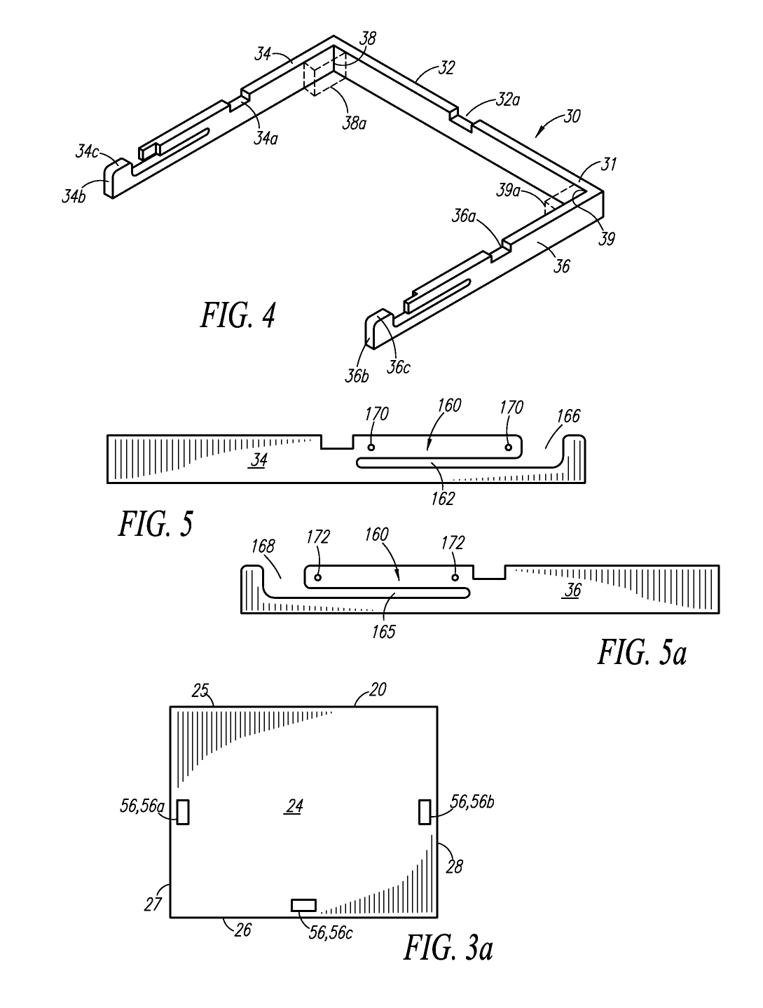

Referring now more specifically to FIGS. 3, 3A, and 6, the complementary attachment means 50 of base 30 allows the platform 20 to be removably attached to base 30. More specifically, the attachment means 56 of platform 20 detachably engages the complementary attachment means 50 of base 30, thereby removably securing platform 20 to base 30. Thus, when placing the lower surface 24 of platform 20 atop an upper surface 31 of base 30, the attachment means 56a, 56b, and 56c are aligned respectively with complementary attachment means 50a, 50b, and 50c.

Suitable means 50 for attachment include, but are not limited hook-and-loop fastener systems, snap-fit mechanisms, and combinations thereof. Preferably, attachment means 50 is magnetic, thereby being attracted to any magnetically attractive or magnetically conductive surface 58, such as the steel flange 59 defining attachment means 56. Attachment means 56 is more specifically shown and described herein as a planar flange 59 constructed of steel or other material being attractive magnetically to a magnet. Alternatively, flange 59 may be constructed from any one of a variety of materials and enveloped with a magnetically attractive or magnetically conductive substance or layer of material.

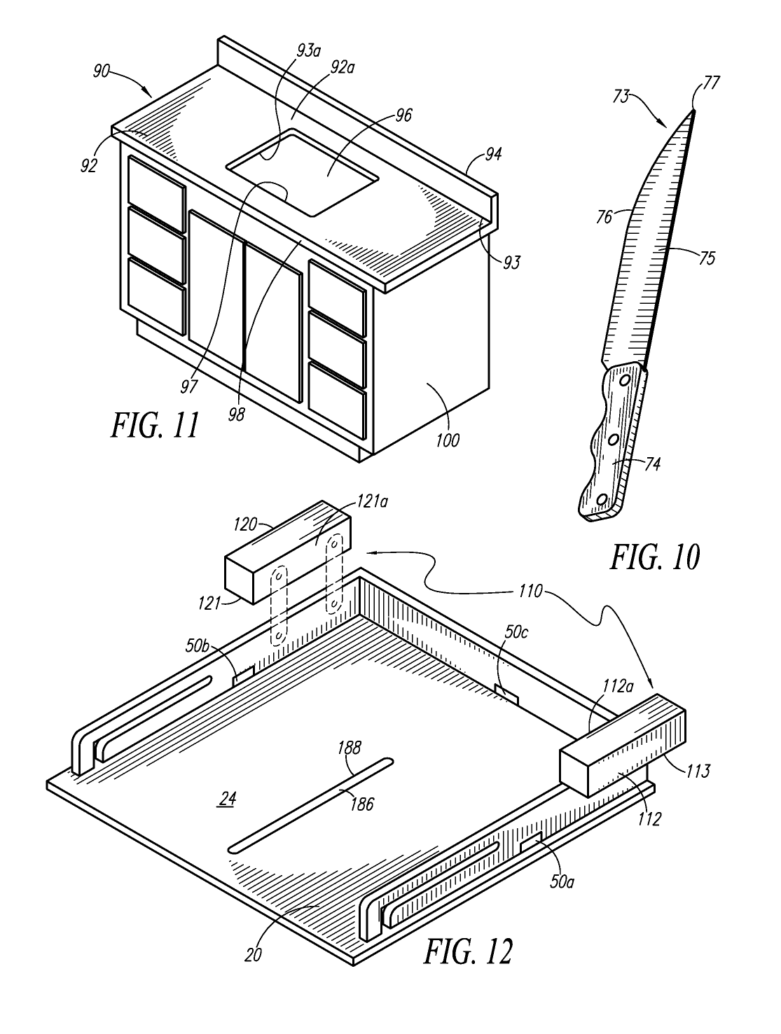

Referring now more specifically to FIGS. 1, and 7-10, a securement means 60 is disclosed for removably attaching a plurality of implements 70, such as cutting instruments 71 and cutting instrument accessories, e.g., blade sharpener (not shown) to the cutting board device 10. Suitable methods for attachment may include, but are not limited to hook-and-loop fastener systems, adhesive bonding, and combinations thereof. Preferably, however, securement means 60 is defined as being magnetic, thereby being attracted to any magnetically attractive or magnetically conductive surface 72, such as the steel blade 75 of a knife 73, wherein knife 73 includes a handle 74 and a blade 75, the blade 75 defining a cutting edge 76 and a tip 77. Thus, in accordance to the preferred embodiment, positioning of a magnetically attractive or magnetically conductive cutting instrument(s) 71 onto the securement means 60 ensures fixed engagement by the cutting instrument(s) 71 thereto.

In accordance to one embodiment of the present invention, the securement means 60 comprises an elongated member 62 having a first end 64 opposing a second end 65, and an upper surface 67, and a lower surface or blade contacting surface 68. The member 62 is preferably rigid, thereby imparting enhanced transverse support to the base 30.

Elongated member 62 is defined as being magnetic and provides a magnetic pull force sufficient for ensuring a plurality of cutting instruments 71, and more particularly knives 73, remain in a fixedly secured, stationary position against elongated member 62, and particularly when cutting board device 10 is raised and lowered via a lifting means 110 (to be described later in greater detail). Thus, elongated member 62 magnetically secures a plurality of knives 73 thereto. In reference to FIG. 1, the blade 75 portion of a pair of knives 73 is shown magnetically attached to elongated member 62, thereby removably securing the knives 73 thereto.

The magnetic securement means 60 may comprise a wide variety of permanent magnets including rare earth magnets, alnico magnets, ceramic magnets, and flexible magnets. Other suitable magnets for use as described hereinabove may include rare earth magnets such as Samarium Cobalt and neodymium iron classes.

Ceramic or Ferrite magnets are made of a composite of iron oxide and barium or strontium carbonate. These materials are readily available and at a lower cost than other types of materials used in permanent magnets making it desirable due to the lower cost. Ceramic magnets are produced using pressing and sintering, but are brittle and require diamond wheels if grinding is necessary. These magnets are made in different grades. Ceramic grade 1 is an isotropic grade having equal magnetic properties in all directions. Ceramic grades 5 and 8 are anisotropic grades. Anisotropic magnets are magnetized in the direction of pressing. The anisotropic method delivers the highest energy product among ceramic magnets at values up to 3.5 MGOe (Mega Gauss Oersted). Ceramic magnets possess a good balance of magnetic strength, resistance to demagnetization and low cost.

Flexible magnets are magnets made of flexible materials that are bonded with a magnetic material. Flexible magnets are advantageous in that they may be bent, coiled, twisted, or otherwise machined into almost any desired shape without depleting their magnetic field. Flexible magnets are corrosion resistant, do not need a coating, are easily machined, and may be bonded with a high magnetic energy material.

Rare earth metal magnets are composed of more expensive magnetic material. Rare earth magnets may be coated onto a flexible material, e.g., plastic or nylon, and will provide excellent magnetic strength and flexibility. These magnets can also be manufactured so as to be very thin.

Alnico magnets are made primarily from a composite of aluminum, nickel, and cobalt with small amounts of other elements added to enhance the properties of the magnet. Alnico magnets possess excellent temperature stability, good resistance to demagnetization due to shock, but are easily demagnetized. Alnico magnets are produced by two typical methods, namely, casting or sintering. Sintering offers superior mechanical characteristics, whereas casting delivers higher energy products (up to 5.5 MGOe) and allows for the design of intricate shapes. Alnico magnets are made in different grades. Grades 5 and 8, which are anisotropic grades, are two very common grades. Anisotropic grades provide for a preferred direction of magnetic orientation. Alnico magnets have been replaced in many applications by ceramic and rare earth magnets.

The elongated member 62 is further adapted and configured for slidably engaging a guide system 160 of the base 30, the guide system 160 facilitating removal of member 62 with or without cutting instruments 71 attached thereto. The guide system 160 comprises a first elongated slot 162 formed in the first vertical wall 34, and a complementary second elongated slot 165 formed in the second vertical wall 36. The elongated slots 162 and 165 are slidably engaged intimately by the member 62. More specifically, opposing flanges 64a and 65a (to be described hereinbelow) of member 62 slidably engage the elongated slots 162 and 165, respectively, in a snug, intimate manner.

The first end 64 and second end 65 of member 62 each respectively includes a flange 64a, 65a, respectively, extending outwardly therefrom, each flange 64a, 65a also functioning as a bracket for securably supporting a securement device adjustment assembly 150, the assembly 150 comprising a pair of spring-biased handles 152, the handles 152 each comprising a knob 154 having an elongated pin 156 coupled thereto. Each flange 64a, 65a includes an upwardly projecting segment 64b, 65b, respectively, having a receiving hole 66 through which a respective pin 156 of the handles 152 is slidably received. Upwardly projecting segment 64b, 65b each having an inner surface to which a cap 157 is mounted, the cap 157 having a central hole aligned axially with each respective receiving hole 66. The handles 152 are each biased with a spring 158 disposed within a respective cap 157. In a resting position, the pin 156 of each handle 152 is biased via spring 158 inwardly toward a respective arm 80, 84. The handles 152 are pulled to retract respective pins 156.

The elongated member 62 further comprises a first arm 80 and a second arm 84 for slidably engaging an inner side edge 134 and 136 of respective vertical walls 34, 36, thereby maintaining elongated member 62 horizontally aligned as elongated member 62 slidably traverses inner side edges 134 and 136 of vertical walls 34, 36, and slots 162, 165, respectively. The first arm 80 extends vertically from the first end 64 of elongated member 62, and the second arm 84 extends vertically from the second end 65 of elongated member 62.

The first arm 80 is contiguous to the blade contacting surface 68 and oriented adjacent to flange 64a, and wherein the second arm 84 is contiguous to the blade contacting surface 68 and oriented adjacent to flange 65a.

In order to allow for the removal of the securement means 60 from the base 30, a first egress opening 166 and a second egress opening 168 are provided. The first egress opening 166 is defined in vertical side wall 34, proximal to forward vertical edge 34b, and wherein first egress opening 166 is in contiguous, fluid communication with first elongated slot 162. The second egress opening 168 is defined in vertical side wall 36, proximal to forward vertical edge 36b and wherein second egress opening 168 is in contiguous, fluid communication with second elongated slot 165.

Significantly, when platform 20 is detachably connected to base 30, the elongated slots 162 and 165 and egress openings 166 and 168 provide space through which elongated member 62 travels, thereby allowing the member 62 with attached knives 73 to be removed from the cutting board device 10 without detaching platform 20 from base 30.

In order to prevent inadvertent or unintentional removal of member 62 and/or cutting instruments 71 from the base 30, a series of pin receiving apertures 170 and 172 are defined spatially along vertical sidewalls 34 and 36, respectively, proximally above elongated slots 162 and 165. The pin receiving apertures 170 defined through first vertical sidewall 34 are axially aligned with pin receiving apertures 172 defined through second vertical sidewall 36. Pin receiving apertures 170 and 172 are sized to intimately receive handle pins 156. Because handle pins 156 are biased inwardly, as member 62 is slidably directed along elongated slots 162, 165, the pins 156 of handles 152, upon engagement with pin receiving apertures 170, 172, are received and intimately held within the pin receiving apertures 170, 172, thereby detachably securing securement means 60 to base 30 about a series of longitudinal positions selectively-desired by user.

Thus, by preventing inadvertent or unintentional removal of securement means 60 and/or cutting instruments 71 from the cutting board device 10, the securement device adjustment assembly 150 and corresponding pin receiving apertures 170, 172 coordinate to provide an important safety feature.

In order to release elongated member 62 from a detachably locked position, both handles 152 must be pulled and held simultaneously, thereby retracting the pins 156 from pin receiving apertures 170, 172, and while pins 156 are maintained in a retracted position, member 62 may be slidably moved along slots 162, 165 to a desired longitudinal position or removed from the base 30 by slidably directing elongated member 62 through first egress opening 166 and second egress opening 168.

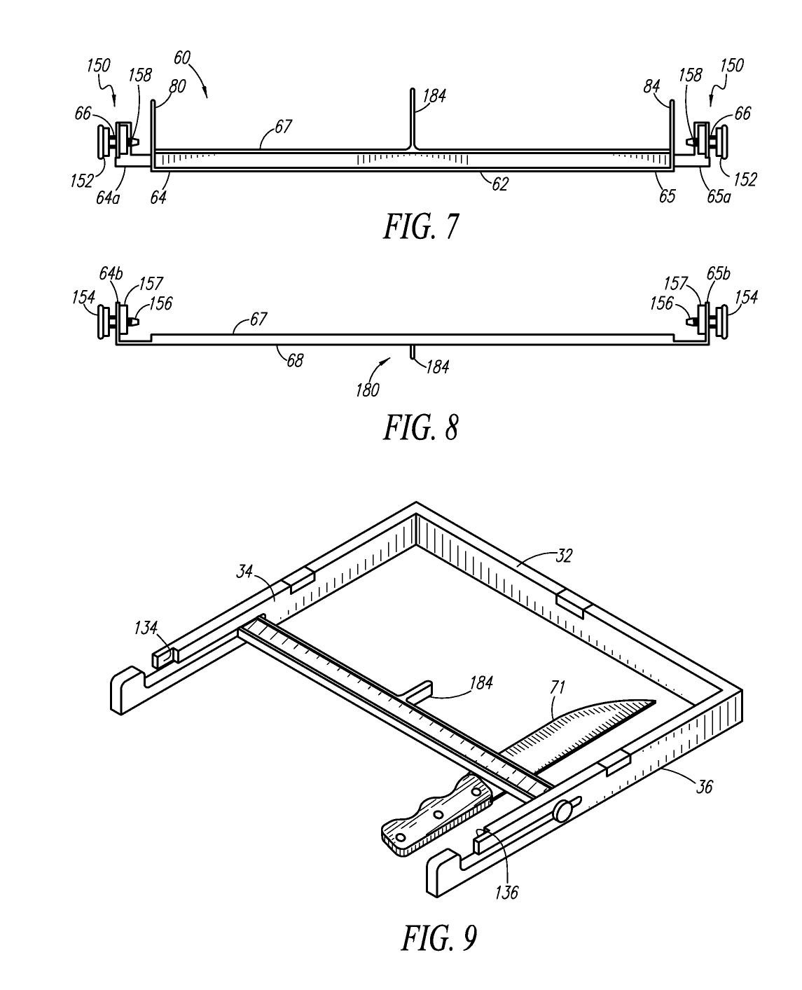

Referring now to FIGS. 7-9, and 12, an attachment means alignment mechanism 180 is disclosed, wherein the attachment means alignment mechanism 180 comprises a spline 184 and a spline receiver 186, the spline receiver 186 being slidably engaged by the spline 184. The attachment means alignment mechanism 180 is adapted and configured to maintain the securement means 60 in a horizontal orientation as securement means 60 is slidably directed along first and second elongated slots 162 and 165.

More specifically, the spline 184 is molded integral to or suitably mounted perpendicularly to elongated member 62 about an elongated centerline thereof. The spline receiver 186 is defined as a channel 188 defined in and extending longitudinally along the planar lower surface 24 of platform 20, the channel 188 being oriented perpendicular with respect to rear side wall 26 of platform 20. The spline 184 defines an outer configuration conforming substantially to the circumferential surface of channel 188, thereby allowing spline 184 to slidably engage the channel 188 in a snug-fit, smooth manner. Therefore, spline 184 is envisioned to define an arcuate or concave shape.

Thus, in order to facilitate quick, easy, and efficient removal of knives 73 from securement means 60, handles 152 are protracted (pulled outward axially) and held while simultaneously slidably directing elongated member 62 along elongated slots 162 and 165 toward egress openings 166 and 168 through which elongated member 62 may be removed.

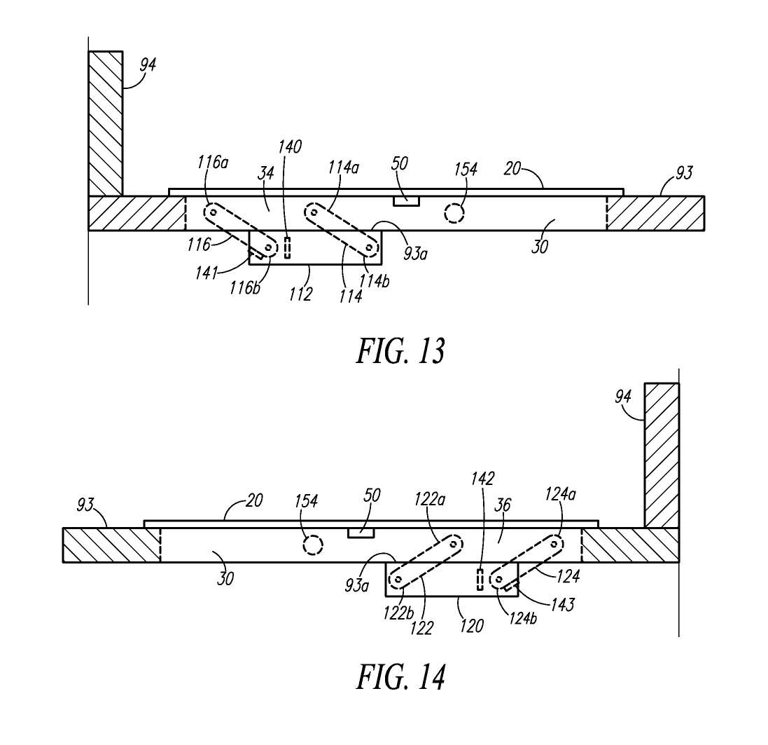

Referring now to FIGS. 1, and 11-14, in further accordance to the preferred embodiment of the present invention, the cutting board device 10 integrally supported by a countertop 90 is disclosed, wherein countertop 90, typically mounted atop a cabinet 100, includes a main body 92 having a backsplash 94 extending a running length of a rear side 93 of main body 92. The main body 92 includes an opening 96 formed therein and defined by rectangular or square boundary 97, the opening 96 being sized for accommodating the cutting board device 10. The cutting board device 10 is movable in a vertically-settable fashion such that cutting board device 10 may be settable in a raised position or in a lowered, recessed position within opening 96 and in substantial flush orientation with countertop upper surface 92a. The device 10 is illustrated in an elevated position above the main body 92 in FIG. 1, and is illustrated in a lowered, recessed position within opening 96 in FIGS. 13-14.

A lifting means 110 is provided for allowing cutting board device 10 to move between settable raised and lowered positions. Lifting means 110 comprises a pair of brackets 112 and 120 each having a pair of lift members 114, 116 and 122, 124, respectively, pivotally mounted thereto. First bracket 112 having an upper side 113 mounted to a lower surface 93a of countertop 90 adjacent a lateral edge of boundary 97. A lower end 114b, 116b of each pair of lift members 114, 116 is pivotally mounted spatially to an inner side 112a of first bracket 112. An upper end 114a, 116a of each pair of lift members 114, 116 is pivotally mounted spatially to vertical side wall 34, proximal to rear vertical wall 32, and below attachment means. Second bracket 120 having an upper side 121 mounted to a lower surface of countertop 90 adjacent an opposing lateral edge of boundary 97. A lower end 122b, 124b of each pair of lift members 122, 124 is pivotally mounted spatially to an inner side 121a of second bracket 120. An upper end 122a, 124a of each pair of lift members 122, 124 is pivotally mounted spatially to vertical side wall 36, proximal to rear vertical wall 32, and below attachment means 50.

To raise the cutting board device 10, user grasps and raises the platform 20 pivotally toward a forward countertop edge 98 until reaching a fully raised position, as shown in FIG. 1. To lower the cutting board device 10, user grasps platform 20 and lowers the platform 20 pivotally to a downward, resting position, as shown in FIGS. 13-14.

In order to limit pivoting travel by the lift members 114, 116 and 122, 124, a first abutment boss 140 may be securable upon the inner side 112a of first bracket 112 and a second abutment boss 142 may be securable upon the inner side 121 a of second bracket 120. A first opposing abutment boss 141 may be securable upon the inner side 112a of first bracket 112 and a second opposing abutment boss 143 may be securable upon the inner side 121a of second bracket 120.

It is envisioned that the various embodiments, as separately disclosed, are interchangeable in various aspects, so that elements of one embodiment may be incorporated into one or more of the other embodiments, and that specific positioning of individual elements may necessitate other arrangements not specifically disclosed to accommodate performance requirements or spatial considerations.

It is to be understood that the embodiments and claims are not limited in its application to the details of construction and arrangement of the components set forth in the description and illustrated in the drawings. Rather, the description and the drawings provide examples of the embodiments envisioned, but the claims are limited to the specific embodiments. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

What is claimed is:

1. A cutting board device, the device comprising:
a platform, the platform comprising:
a planar upper surface and a planar lower surface;
a plurality of vertical side walls integrally joining the upper surface and lower surface;
a base detachably connected to the platform, the base comprising:
a rear vertical wall, the rear vertical wall having outer ends; and
a pair of vertical side walls, the pair of vertical side walls are respectively mounted perpendicularly or formed integral perpendicularly to the outer ends of the rear vertical wall;
means for detachably connecting the platform to the base; and
means for removably attaching a plurality of implements to the cutting board device.

2. The device of claim 1, wherein the platform is constructed of a lightweight, rigid material.

3. The device of claim 1, wherein the means for detachably connecting the platform to the base includes an attachment mechanism and a complementary attachment mechanism.

4. The device of claim 3, wherein the complementary attachment mechanism comprises a plurality of magnetic plugs spatially disposed about an upper surface of the base.

5. The device of claim 3, wherein the attachment mechanism comprises a plurality of flanges mounted spatially to the lower surface of the platform, the plurality of flanges is oriented about the lower surface of the platform in a manner so as to align with the complementary attachment mechanism when placing the lower surface of the platform atop an upper surface of the base.

6. The device of claim 5, wherein the plurality of flanges is constructed of a magnetically attractive material.

7. The device of claim 1, wherein the means for removably attaching the plurality of implements to the cutting board device is a securement mechanism.

8. The device of claim 7, wherein the securement mechanism is magnetic.

9. The device of claim 7, wherein the securement mechanism comprises an elongated member having a first end opposing a second end, and an upper surface and an implement contacting surface.

10. The device of claim 5, wherein the base further comprises a guide system.

11. The device of claim 10, wherein the guide system is slidably traversed by the elongated member in a horizontally-maintained, aligned manner.

12. A cutting board device, the device comprising:
a platform, the platform comprising:
a planar upper surface and a planar lower surface;
a plurality of vertical side walls integrally joining the upper surface and lower surface;
a base detachably connected to the platform, the base comprising:
a rear vertical wall, the rear vertical wall having outer ends; and
a pair of vertical side walls, the pair of vertical side walls are respectively mounted perpendicularly or formed integral perpendicularly to the outer ends of the rear vertical wall;
a means for detachably connecting the platform to the base;
a means for removably attaching a plurality of implements to the cutting board device; and
a lifting means.

13. The device of claim 12, wherein the lifting means allowing the cutting board device to move between settable raised and lowered positions, the lifting means comprises:
a pair of brackets; and
two pairs of lift members.

14. The device of claim 13, wherein the pair of brackets comprising a first bracket and a second bracket, the first bracket having one pair of the two pairs of lift members pivotally mounted thereto about lower ends of the one pair of the two pairs of lift members, and the second bracket having a second pair of the two pairs of lift members pivotally mounted thereto about lower ends of the second pair of the two pairs of lift members.

15. The device of claim 14, wherein the first bracket being mounted to a lower surface of a countertop, adjacent a lateral edge of an opening of the countertop, and wherein the second bracket being mounted to the lower surface of the countertop, adjacent an opposing lateral edge of the opening of the countertop.

16. The device of claim 14, wherein the one pair of the two pairs of lift members having upper ends pivotally mounted to a first vertical side wall of the pair of vertical side walls of the base, and the second pair of the two pairs of lift members having upper ends pivotally mounted to a second vertical side wall of the pair of vertical side walls of the base.
